(19) United States
(12) Patent Application Publication
(10) Pub. No.: US 2026/0023619 A1
(43) Pub. Date: Jan. 22, 2026

(54) LOAD DEVICE DETERMINATION

(71) Applicant: Tencent Technology (Shenzhen) Company Limited, Shenzhen (CN)

(72) Inventors: Jiajun LU, Shenzhen (CN); Zhiming CHEN, Shenzhen (CN)

(73) Assignee: Tencent Technology (Shenzhen) Company Limited, Shenzhen (CN)

(21) Appl. No.: 19/341,210

(22) Filed: Sep. 26, 2025

Related U.S. Application Data
(63) Continuation of application No. PCT/CN2024/099479, filed on Jun. 17, 2024.

(30) Foreign Application Priority Data
Aug. 28, 2023 (CN) 202311097365.6

(51) Int. Cl. G06F 9/50

(52) U.S. Cl. CPC G06F 9/505

(57) ABSTRACT

A first data request of a first access device is obtained, the first data request requests to begin a game. A target load cluster is determined, the target load cluster includes a first group of load devices. A second group of load devices is determined from the first group based on respective device load information of the first group. The second group is a first subset of the first group, the first group are split into the first subset and a second subset. For each second load device, the first subset includes at least a first load device with a first load capability superior to the second load device. Load capabilities of each pair of first load devices in the first subset are not superior to each other. A target first load device is selected from the first subset, the game is created on the target first load device.

### RELATED APPLICATIONS

The present application is a continuation of International Application No. PCT/CN2024/099479, filed on Jun. 17, 2024, which claims priority to Chinese Patent Application No. 202311097365.6, filed on Aug. 28, 2023. The entire disclosures of the prior applications are hereby incorporated by reference.

### FIELD OF THE TECHNOLOGY

This disclosure relates to the field of computers, including a load device determining method and apparatus, a storage medium, and an electronic device.

### BACKGROUND OF THE DISCLOSURE

Currently, in a related technology, a load device is mainly determined by using a random routing policy, that is, game battles are evenly distributed to load devices in a quantity dimension. After a game request is transmitted to a matching server, load devices are randomly selected, so that quantities of game battles created by the load devices are as close as possible. However, it is difficult to implement a complete balance based on the foregoing random algorithm. Some load devices may create relatively small quantities of game battles and resource utilization is low. In some examples, an excessively large quantity of battles are randomly distributed to the same load device at a time point, leading to a creation failure. Therefore, in the related technology, resource utilization of some load devices in a load cluster is relatively low, and it is difficult to truly achieve a load balance of load devices in the cluster.

In view of the foregoing problem, no effective solution is provided yet.

### SUMMARY

Embodiments of this disclosure provide a load device determining method and apparatus, a storage medium, and an electronic device, to resolve at least a technical problem of relatively low resource utilization of some load devices in a load cluster.

Some aspects of the disclosure provide a method of load device determination. In some examples, a first data request that is transmitted by a first access device is obtained, the first data request requests to begin a game in a current application. A target load cluster is determined based on network parameters between the first access device and a plurality of load clusters, the target load cluster is a load cluster in the plurality of load clusters and satisfies a preset network parameter condition, the target load cluster includes a first group of load devices. A second group of load devices is determined from the first group of load devices based on respective device load information of the first group of load devices. Device load information of a load device in the first group of load devices includes a plurality of device load parameters in a plurality of dimensions, the plurality of device load parameters indicate a load capability for the load device. The second group of load devices is a first subset of the first group of load devices, the first group of load devices includes the first subset and a second subset, the second subset includes load devices of the first group of load devices that are not in the first subset. For each second load device in the second subset, the first subset includes at least a first load device with a first load capability superior to the second load device. Load capabilities of each pair of first load devices in the first subset are not superior to each other. A target first load device is selected from the first subset, the game is created on the target first load device.

According to an aspect of the embodiments of this disclosure, a load device determining method is provided, the method being performed by an electronic device, and including: obtaining a first data request transmitted by a first access device, the first data request being configured for requesting to begin a game in a current application; determining a target load cluster based on network parameters between the first access device and a plurality of load clusters in response to the first data request, the target load cluster being a load cluster that is among the plurality of load clusters and whose network parameter meets a preset network parameter condition; determining a second group of load devices from a first group of load devices based on a first group of device load information reported by the first group of load devices in the target load cluster, each piece of device load information in the first group of device load information comprising a device load parameter configured for indicating a load capability of a corresponding load device in different dimensions, a load capability of any load device in the second group of load devices being superior to a load capability of another load device in the first group of load devices except the second group of load devices, and load capabilities of any two load devices in the second group of load devices being not superior to each other; and determining a first load device from the second group of load devices, and creating the game on the first load device.

According to another aspect of the embodiments of this disclosure, a load device determining apparatus is further provided, the apparatus being deployed on an electronic device, and including: an obtaining module, configured to obtain a first data request transmitted by a first access device, the first data request being configured for requesting to begin a game in a current application; a determining module, configured to determine a target load cluster based on network parameters between the first access device and a plurality of load clusters in response to the first data request, the target load cluster being a load cluster that is among the plurality of load clusters and whose network parameter meets a preset network parameter condition; a processing module, configured to determine a second group of load devices from a first group of load devices based on a first group of device load information reported by the first group of load devices in the target load cluster, each piece of device load information in the first group of device load information including a device load parameter configured for indicating a load capability of a corresponding load device in different dimensions, a load capability of any load device in the second group of load devices being superior to a load capability of another load device in the first group of load devices except the second group of load devices, and load capabilities of any two load devices in the second group of load devices being not superior to each other; and a creation module, configured to determine a first load device from the second group of load devices, and create the game on the first load device.

According to still another aspect of the embodiments of this disclosure, a computer-readable storage medium is further provided, the computer-readable storage medium having a computer program stored therein, and the computer program being configured to, when run, performing the foregoing load device determining method.

According to yet another aspect of the embodiments of this disclosure, a computer program product is provided, the computer program product including a computer program, and the computer program being stored in a computer-readable storage medium (e.g., non-transitory computer-readable storage medium). A processor (an example of processing circuitry) of a computer device reads the computer program from the computer-readable storage medium and executes the computer program, to cause the computer device to perform the foregoing load device determining method.

According to still yet another aspect of the embodiments of this disclosure, an electronic device is further provided, including a memory and a processor, the memory having a computer program stored therein, and the processor being configured to perform the foregoing load device determining method by using the computer program.

In the embodiments of this disclosure, the first data request transmitted by the first access device is obtained, the first data request being configured for requesting to begin a game in a current application; and the target load cluster is determined based on the network parameters between the first access device and the plurality of load clusters in response to the first data request, the target load cluster being the load cluster that is among the plurality of load clusters and whose network parameter meets the preset network parameter condition. The principle of a Pareto optimal solution is similar to the load balancing principle. Therefore, when a load device corresponding to a game is to be determined, a suitable load device may be determined based on the Pareto optimal solution, to reduce impact of a load of the game on the load device as much as possible. In some aspects, the second group of load devices may be determined from the first group of load devices based on the first group of device load information reported by the first group of load devices in the target load cluster, each piece of device load information in the first group of device load information including the device load parameter configured for indicating the load capability of the corresponding load device in the different dimensions, the load capability of any load device in the second group of load devices being superior to the load capability of another load device in the first group of load devices except the second group of load devices, and the load capabilities of any two load devices in the second group of load devices being not superior to each other, thereby finding the Pareto optimal solution for the load device in the load cluster. Then the first load device is determined from the second group of load devices, and the game is created on the first load device. Load devices on which a game is created are load devices corresponding to the Pareto optimal solution, the load devices corresponding to the Pareto optimal solution have relatively good load capabilities, and the load capabilities of the load devices corresponding to the Pareto optimal solution are slightly different. Therefore, the Pareto optimal solution of the load device in the load cluster is found, to create a game on the load device corresponding to the Pareto optimal solution, thereby efficiently implementing load balancing, achieving technical effects of increasing resource utilization of the load device and reducing an overload possibility of the load device, and further resolving the technical problem of relatively low resource utilization of some load devices in the load cluster.

### BRIEF DESCRIPTION OF THE DRAWINGS

FIG. 1 is a schematic diagram of an application environment of an example load device determining method according to an embodiment of this disclosure.

FIG. 2 is a schematic flowchart of an example load device determining method according to an embodiment of this disclosure.

FIG. 3 is a schematic diagram of an example load device determining method according to an embodiment of this disclosure.

FIG. 4 is a schematic diagram of another example load device determining method according to an embodiment of this disclosure.

FIG. 5 is a schematic diagram of another example load device determining method according to an embodiment of this disclosure.

FIG. 6 is a schematic diagram of another example load device determining method according to an embodiment of this disclosure.

FIG. 7 is a schematic diagram of another example load device determining method according to an embodiment of this disclosure.

FIG. 8 is a schematic diagram of another example load device determining method according to an embodiment of this disclosure.

FIG. 9 is a schematic diagram of another example load device determining method according to an embodiment of this disclosure.

FIG. 10 is a schematic diagram of another example load device determining method according to an embodiment of this disclosure.

FIG. 11 is a schematic diagram of another example load device determining method according to an embodiment of this disclosure.

FIG. 12 is a schematic diagram of a structure of an example load device determining apparatus according to an embodiment of this disclosure.

FIG. 13 is a schematic diagram of a structure of an example load device determining product according to an embodiment of this disclosure.

FIG. 14 is a schematic diagram of a structure of an example electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Herein, terms “first”, “second”, and the like in the specification, the claims, and the foregoing accompanying drawings of this disclosure are intended to distinguish between similar objects, rather than describe a specific sequence or order. It is to be understood that such used data is interchangeable where appropriate so that the embodiments of this disclosure described here can be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

Examples of terms involved in the aspects of the disclosure are briefly introduced. The descriptions of the terms are provided as examples only and are not intended to limit the scope of the disclosure.
Peak concurrent users (PCU): a maximum quantity of concurrent online persons.
FPS: a first-person shooting game.
Load cluster: a service cluster for actually beginning a battle. Players successfully matched play a game in a battle on the load cluster, for example, entering a map for a battle and searching for supplies in a shooting game, and entering a battle for a confrontation in a role-playing game. Because global players are distributed in different regions, dozens of load clusters are deployed globally, to improve battle experience of players with different network delays. After being successfully matched by a matching server in the same lobby cluster, the players enter a load cluster in a region for a game battle.
dscenter (corresponding to the following device allocation process): dsc for short. Each load cluster has a plurality of parallel dscenters for simultaneously managing load device allocation of the entire cluster.
dsagent (corresponding to the following device agent process): dsa for short. For each load device, one dsagent is configured for managing initialization, and data synchronization and recovery of an actual battle ds process on the load device.
OOM: out of memory, which may cause a process to fail and stop.
Pareto optimality: When a plurality of pieces of multidimensional data are compared, if each dimension of a piece of current data is superior to that of another piece of data, the current data is superior to the another piece of data. However, if several pieces of data are superior to another piece of data, but the pieces of data are not superior to each other, the foregoing several pieces of data are data with Pareto optimality.

This disclosure is described below with reference to embodiments.

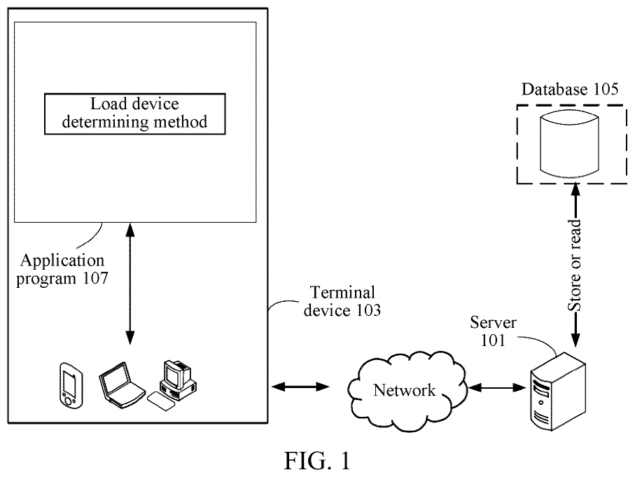

According to an aspect of the embodiments of this disclosure, a load device determining method is provided. In some embodiments, in this embodiment, the foregoing load device determining method may be applied to a hardware environment shown in FIG. 1 including a server 101 and a terminal device 103. As shown in FIG. 1, the server 101 is connected to the terminal device 103 through a network, and may be configured to provide a service for the terminal device or an application program installed on the terminal device. The application program may be a video application program, an instant messaging application program, a browser application program, an education application program, a game application program, or the like. A database 105 may be disposed on the server 101 or independently of the server 101, and be configured to provide a data storage service for the server 101, for example, a game data storage server. The foregoing network may include, but is not limited to: a wired network and a wireless network. The wired network includes: a local area network, a metropolitan area network, and a wide area network. The wireless network includes: Bluetooth, Wi-Fi, and another network that implements wireless communication. The terminal device 103 may be a terminal on which an application program is configured, and may include, but is not limited to, at least one of the following computer devices: a mobile phone (such as an Android phone or an iOS phone), a notebook computer, a tablet computer, a palmtop computer, a mobile Internet device (MID), a PAD, a desktop computer, a smart television, an intelligent voice interaction device, a smart home appliance, an in-vehicle terminal, an aircraft, a virtual reality (VR for short) terminal, an augmented reality (AR for short) terminal, a mixed reality (MR for short) terminal, or the like. The foregoing server may be a single server, a server cluster including a plurality of servers, or a cloud server.

As shown in FIG. 1, the foregoing load device determining method may be implemented on the terminal device 103 through the following operations:
S1: Obtain, on the terminal device 103, a first data request transmitted by a first access device, the first data request being configured for requesting to begin a game in a current application.
S2: Determine a target load cluster on the terminal device 103 based on network parameters between the first access device and a plurality of load clusters in response to the first data request, the target load cluster being a load cluster that is among the plurality of load clusters and whose network parameter meets a preset network parameter condition.
S3: Determine, on the terminal device 103, a second group of load devices from a first group of load devices based on a first group of device load information reported by the first group of load devices in the target load cluster, each piece of device load information in the first group of device load information including a device load parameter configured for indicating a load capability of a corresponding load device in different dimensions, a load capability of any load device in the second group of load devices being superior to a load capability of another load device in the first group of load devices except the second group of load devices, and load capabilities of any two load devices in the second group of load devices being not superior to each other.
S4: Determine, on the terminal device 103, a first load device from the second group of load devices, and create the game on the first load device.

In some embodiments, in this embodiment, the foregoing load device determining method may be implemented by a server, for example, the server 101 shown in FIG. 1; or may be jointly implemented by a terminal device and a server.

The foregoing is merely an example. This is not limited in this embodiment.

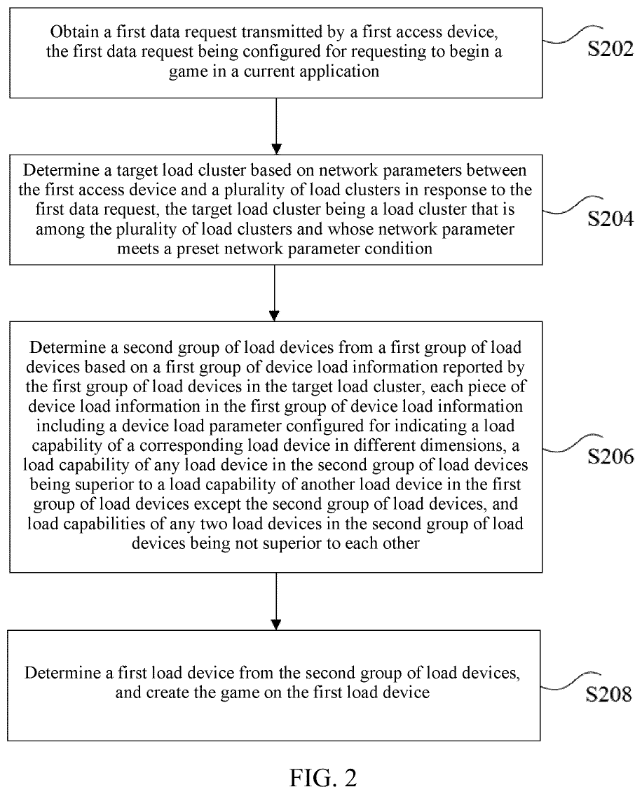

In some embodiments, in an example implementation, as shown in FIG. 2, the foregoing load device determining method includes the following operations.
S202: Obtain a first data request transmitted by a first access device, the first data request being configured for requesting to begin a game in a current application.

In some embodiments, in this embodiment, the first access device may include, but is not limited to, a device on which a user logs in to a current account. The current application is an application configured for entering a game. The current application may include, but is not limited to, a game application, a social application, a shopping application, or the like. The game application is used as an example. The game application may include, but is not limited to, a shooting game application, a chess game application, a role-playing game application, a policy game application, or the like, or may be a combination of the foregoing plurality of types of game applications. The account may include, but is not limited to, an account registered on a related server of the game application in advance, or may include, but is not limited to, an account registered on a related server of the game application during transmission of a data request. The foregoing is merely an example. This is not limited in this embodiment.

In some embodiments, in this embodiment, the first data request may include, but is not limited to, being configured for requesting to begin a game, or being configured for forming, with another account, a group of accounts configured for requesting to begin the foregoing game. The another account and the current account may be in the same geographical area or different geographical areas.

An execution body of the foregoing load device determining method may include, but is not limited to, a matching server configured to create a game, for example, may include, but is not limited to, a regional server or a pre-configured server configured to perform matching on a game account.

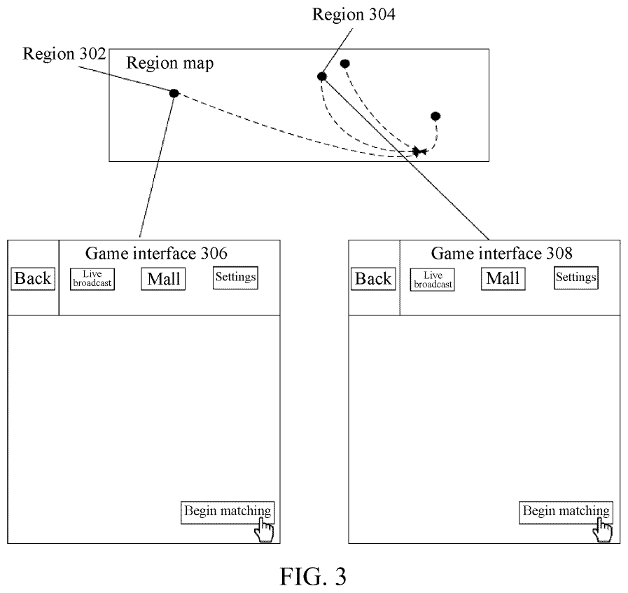

FIG. 3 is a schematic diagram of an example load device determining method according to an embodiment of this disclosure. As shown in FIG. 3, two players located in a region 302 and a region 304 play a game respectively through a game interface 306 and a game interface 308. After obtaining an interaction operation corresponding to “begin matching” on the game interface, the two players may jointly participate in a game created by a game matching server. In this case, the interaction operation of clicking/tapping the “begin matching” is an operation of transmitting the first data request by using the first access device.

In this operation, the first data request transmitted by the first access device needs to be obtained, and the request is configured for requesting to begin the game in the current application. For example, a user clicks/taps a “begin matching” button by using a game application on a mobile device, and in this case, a request is transmitted to the server.

S204: Determine a target load cluster based on network parameters between the first access device and a plurality of load clusters in response to the first data request, the target load cluster being a load cluster that is among the plurality of load clusters and whose network parameter meets a preset network parameter condition.

In some embodiments, in this embodiment, the network parameter may be a parameter that can independently reflect a network characteristic. The network parameter may include, but is not limited to, a network delay, a cluster load, and the like. The network parameters between the first access device and the plurality of load clusters are obtained, to determine the target load cluster that is among the plurality of load clusters and whose network parameter meets the preset network parameter condition.

For example, when a game is to begin, network delay ranges of 10 players for five load clusters A, B, C, D, and E are respectively [110 to 120], [30 to 40], [60 to 80], [140 to 160], and [210 to 220] (unit: millisecond). After the matching server succeeds in matching a player and the player enters a game, the matching server requests corresponding load balancing and performs allocation for a single battle. If the load cluster B is not fully loaded, the matching server requests the load cluster B to allocate a corresponding load device to create the game. When the load cluster B is fully loaded, the matching server sequentially attempts to allocate a corresponding load device from a load cluster that is not fully loaded among the load clusters C, A, D, and E to create the game.

The target load cluster may be sequentially determined based on network delays in descending order. In some examples, a load cluster set formed by some load clusters whose delays are less than a preset threshold may be first screened out based on the network delay, and then a corresponding load cluster is randomly selected from the load cluster set. A specific selection manner is not limited in this disclosure.

In some embodiments, in this embodiment, the foregoing preset network parameter condition may be understood as a network delay threshold, a network delay sorting position, or the like that is preset by a system.

For example, the target load cluster may be determined by analyzing the network parameters between the first access device and the plurality of load clusters. The target load cluster is a load cluster meeting the preset network parameter condition. If it is found by analyzing the network parameters that both a delay and a bandwidth of a load cluster are very stable and highly efficient, the load cluster may be determined as the target load cluster.

S206: Determine a second group of load devices from a first group of load devices based on a first group of device load information reported by the first group of load devices in the target load cluster, each piece of device load information in the first group of device load information including a device load parameter configured for indicating a load capability of a corresponding load device in different dimensions, a load capability of any load device in the second group of load devices being superior to a load capability of another load device in the first group of load devices except the second group of load devices, and load capabilities of any two load devices in the second group of load devices being not superior to each other.

In some embodiments, in this embodiment, the first group of load devices may be understood as running load devices managed by the target load cluster. The device load information may represent a load capability of a load device. The first group of device load information may be understood as device load information in a one-to-one correspondence with the first group of load devices. In other words, one piece of device load information corresponds to one load device.

The device load information includes at least two device load parameters that are in the different dimensions and that are configured for indicating the load capability of the load device. The device load parameters may be parameters reflecting the load capability of the load device, such as a first device load parameter and a second device load parameter. That is, the first device load parameter may include, but is not limited to, being formed by a plurality of device load parameters in the same dimension, and the second device load parameter may include, but is not limited to, being formed by a plurality of device load parameters in the same dimension. However, the first device load parameter and the second device load parameter are device load parameters in different dimensions. Therefore, it is difficult to determine the load capability of the corresponding load device by simply combining a value of the first device load parameter and a value of the second device load parameter.

For example, the first device load parameter may include, but is not limited to, a central processing unit (CPU) idle rate, and the second device load parameter may include, but is not limited to, a remaining capacity of an internal memory. Because the CPU idle rate and the remaining capacity of the internal memory are device load parameters that are in different dimensions and that are configured for describing a load capability of a load device, if both a CPU idle rate and a remaining capacity of an internal memory of one load device are superior to those of another load device, the current load device is superior to the another load device. However, when a CPU idle rate of one load device is superior to that of another load device, and a remaining capacity of an internal memory is less than that of the another load device, it is difficult to determine the pros and cons of load capabilities of the two load devices, that is, if several load devices are all superior to another load device, and the load devices are not superior to each other, the load devices are the second group of load devices, that is, the second group of load devices are load devices corresponding to a Pareto optimal solution of the first group of device load information.

In an example embodiment, it is assumed that the first group of load devices is load devices in a load cluster A, and includes several load devices. Device load information reported by the load devices may include a first device load parameter and a second device load parameter that are configured for indicating a load capability of a corresponding load device in different dimensions. Other load devices are selected from the first group of load devices based on a requirement for the second group of load devices, are named load devices C, D, and the like, and are used as part of the second group of load devices. Load capabilities of the load devices are required to be superior to that of another load device in the first group of load devices except the second group of load devices. In addition, load capabilities of any two load devices in the second group of load devices cannot be superior to each other. In other words, a load capability of the load device C cannot be superior to a load capability of the load device D, and vice versa.

The process of determining the second group of load devices based on the device load information reported by the first group of load devices may be better understood by using the foregoing examples for description. Such a design may ensure that the second group of load devices has higher load capabilities, and are balanced with each other, thereby improving performance and reliability of an entire load device system.

S208: Determine a first load device from the second group of load devices, and create the game on the first load device.

In some embodiments, in this embodiment, the first load device may be understood as a load device having a most average load capability in the second group of load devices, or may be understood as any load device in the second group of load devices.

In an example embodiment, after the second group of load devices is determined, a device having a relatively balanced load capability may be selected from the second group of load devices as the first load device, and the game is created on the device. For example, based on indicators such as a processing capability and a capacity of an internal memory of a load device, one of the second group of load devices may be selected as the first load device, and a game service may be enabled on the first load device.

In this embodiment, the first data request transmitted by the first access device is obtained, the first data request being configured for requesting to begin a game in a current application. The target load cluster is determined based on the network parameters between the first access device and the plurality of load clusters in response to the first data request, the target load cluster being the load cluster that is among the plurality of load clusters and whose network parameter meets the preset network parameter condition. The principle of the Pareto optimal solution is similar to the load balancing principle. Therefore, when a load device corresponding to a game is to be determined, a suitable load device may be determined based on the Pareto optimal solution, to reduce impact of a load of the game on the load device as much as possible. In some aspects, the second group of load devices (e.g., the second group of load devices is a first subset in the first group of load devices, the first group of load device includes the first subset and a second subset, the second subset includes load devices that are not in the first subset) may be determined from the first group of load devices based on the first group of device load information reported by the first group of load devices in the target load cluster, each piece of device load information in the first group of device load information including the device load parameter configured for indicating the load capability of the corresponding load device in different dimensions, the load capability of any load device in the second group of load devices being superior to a load capability of another load device in the first group of load devices except the second group of load devices, and the load capabilities of any two load devices in the second group of load devices being not superior to each other, thereby finding the Pareto optimal solution for the load device in the load cluster. Then the first load device is determined from the second group of load devices, and the game is created on the first load device. Load devices on which a game is created are load devices corresponding to the Pareto optimal solution, the load devices corresponding to the Pareto optimal solution have relatively good load capabilities, and the load capabilities of the load devices corresponding to the Pareto optimal solution are slightly different. Therefore, the Pareto optimal solution of the load device in the load cluster is found, to create a game on the load device corresponding to the Pareto optimal solution, thereby efficiently implementing load balancing, achieving technical effects of increasing resource utilization of the load device and reducing an overload possibility of the load device, and further resolving the technical problem of relatively low resource utilization of some load devices in the load cluster.

In addition, in the foregoing entire process of allocating a load device, a database does not need to be queried, so that the allocation can be rapidly completed within a short time, thereby ensuring that loads of the load devices are accurately and reliably updated, and avoiding an online major accident caused by problems such as an unreliable load device status update due to a reporting time sequence problem and overflowing of an internal memory caused by allocation overload of the load devices.

In addition, by using a multi-level pre-withholding mechanism and a load balancing policy, a sharp change in a device parameter caused by a massive rush into one load device within a short time is prevented, thereby ensuring that smooth allocation can be performed for each game, and reducing a game creation failure rate.

As an example solution, the determining a second group of load devices from a first group of load devices based on a first group of device load information reported by the first group of load devices in the target load cluster includes:
obtaining a device load parameter corresponding to each load device in the first group of device load information;
determining a load capability of each load device in the first group of load devices based on the device load parameter by using an enumeration method; and
determining the second group of load devices based on the load capability of each load device.

In some embodiments, in this embodiment, the load capability is a capability of bearing a load quantity and load pressure by the load device. Before the load capability is analyzed, load information of the first group of load devices needs to be accurately obtained. The load device usually has a plurality of relevant parameters, including the first device load parameter and the second device load parameter. The parameters may be CPU utilization, an internal memory occupation rate, and the like.

For example, it is assumed that a computer server is studied, and the first device load parameter may include CPU utilization and the like; and the second device load parameter may include an internal memory occupation rate and the like.

In some embodiments, in this embodiment, the determining a load capability of each load device in the first group of load devices by using an enumeration method may be understood as determining the load capability of each load device by using the enumeration method after the load information of the first group of devices is obtained. The enumeration method is a method for enumerating all possible cases one by one. A load device that can meet a requirement for the second group of load devices is found by enumerating all possible load parameter combinations.

For example, for a load device, a load capability of the load device may be determined by attempting combinations of different CPU utilization and internal memory occupation rates one by one. For example, when the CPU utilization is 80% and the internal memory occupation rate is 70%, the server works normally, that is, a load capability with the combination is indicated. After load capabilities of the first group of load devices are determined, a suitable second group of load devices may be selected based on the capabilities. A device that can meet or exceed the load capabilities of the first group of load devices is selected based on a load capability requirement. If the load capabilities of the first group of load devices are CPU utilization of 90% and an internal memory occupation rate of 80%, the second group of load devices may be selected based on the foregoing requirement for the second group of load devices. For example, five load devices with higher performance may be selected. CPU utilization of the five load devices is respectively 70%, 71%, 71%, 73%, and 67%, and internal memory occupation rates are respectively 32%, 30%, 30%, 29%, and 33%. In this case, load capabilities of any two of the five load devices are not superior to each other.

In an example embodiment, FIG. 4 is a schematic diagram of another example load device determining method according to an embodiment of this disclosure. As shown in FIG. 4, after receiving the foregoing first data request, a matching server determines a target load cluster by obtaining a network parameter of each load cluster, and after determining the target load cluster, determines, based on a load capability, a second group of load devices from a first group of load devices corresponding to the target load cluster. Any load device in the second group of load devices is superior to another load device in the first group of load devices except the second group of load devices. In addition, load capabilities of any two load devices in the second group of load devices are not superior to each other.

Intuitiveness, correctness, and comprehensiveness are presented when the load capability of each load device is determined by using the enumeration method, so that the second group of load devices can be determined more effectively and accurately.

As an example solution, the determining a load capability of each load device in the first group of load devices based on the device load parameter by using an enumeration method includes:
enumerating each load device in the first group of load devices in a first coordinate system, a first coordinate axis of the first coordinate system being associated with the first device load parameter, and a second coordinate axis of the first coordinate system being associated with the second device load parameter; and
determining the load capability of each load device based on a coordinate position of each load device in the first coordinate system, the load capability being related to a first linear distance of a corresponding load device, and the first linear distance being a linear distance between the coordinate position of the corresponding load device and a coordinate origin of the first coordinate system.

In some embodiments, in this embodiment, the first coordinate system may be understood as a coordinate system that is preset based on the first device load parameter and the second device load parameter. Coordinate axes of the first coordinate system are related to the first device load parameter and the second device load parameter. That is, if the first coordinate system is a rectangular coordinate system, a horizontal axis may correspond to the first device load parameter, and a vertical axis may correspond to the second device load parameter.

Enumerating each load device in the first group of load devices in the first coordinate system means that each load device in the first group of load devices is considered one by one. The first coordinate axis of the first coordinate system is related to the first device load parameter. That is, the first device load parameter corresponds to a value on the first coordinate axis. Similarly, the second coordinate axis of the first coordinate system is related to the second device load parameter, and the second device load parameter corresponds to a value on the second coordinate axis.

Next, the load capability of each load device needs to be determined based on the coordinate position of each load device in the first coordinate system. The load capability is related to the linear distance between the coordinate position and the coordinate origin of the first coordinate system. In other words, the load capability of the load device is determined based on a position of the load device in the first coordinate system. A closer position to the coordinate origin indicates a stronger or weaker load capability. A farther position from the coordinate origin indicates a weaker or stronger load capability.

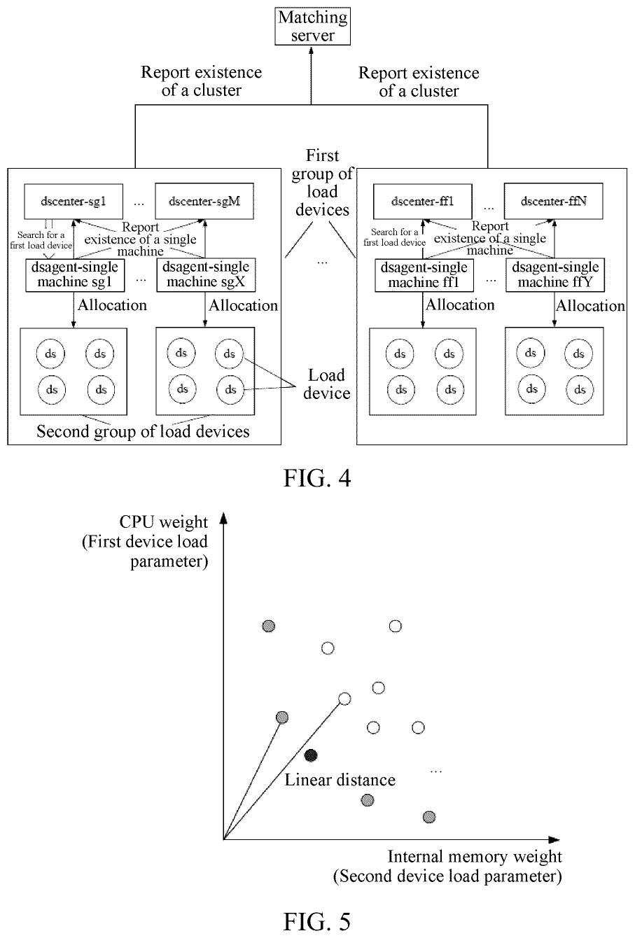

In an example embodiment, FIG. 5 is a schematic diagram of another example load device determining method according to an embodiment of this disclosure. As shown in FIG. 5, it is assumed that a first coordinate axis of a first coordinate system represents a CPU weight parameter of a load device, and a second coordinate axis represents an internal memory weight parameter of the load device. If there are three load devices that are respectively a load device A, a load device B, and a load device C, a value corresponding to a CPU weight parameter of the load device A on the first coordinate axis is 2, and a value corresponding to an internal memory weight parameter on the second coordinate axis is 3; a value corresponding to a CPU weight parameter of the load device B on the first coordinate axis is 5, and a value corresponding to an internal memory weight parameter on the second coordinate axis is 1; and a value corresponding to a CPU weight parameter of the load device C on the first coordinate axis is 3, and a value corresponding to an internal memory weight parameter on the second coordinate axis is 4. Load capabilities of the load devices may be determined based on coordinate positions of the load devices in the first coordinate system. It is assumed that the coordinate origin of the first coordinate system is (0, 0). A coordinate position of the load device A in the first coordinate system is (2, 3), and a load capability of the load device A may be determined based on a linear distance from the coordinate origin. Similarly, a coordinate position of the load device B in the first coordinate system is (5, 1), and a coordinate position of the load device C in the first coordinate system is (3, 4). The load capabilities of the load device B and the load device C may be determined based on the coordinate positions.

In conclusion, determining the load capability based on the coordinate position of each load device in the first coordinate system is a process of performing determining based on a relationship of the linear distance between the coordinate position and the coordinate origin. Load capabilities corresponding to different load devices with device load parameters in different dimensions may be intuitively displayed.

As an example solution, the enumerating each load device in the first group of load devices in a first coordinate system includes:
if both a value of the first device load parameter and a value of the second device load parameter are in a positive correlation with the load capability, determining the coordinate position of each load device in the first coordinate system based on a negative number of the value of the first device load parameter corresponding to each load device and a negative number of the value of the second device load parameter, the load capability being in a negative correlation with the first linear distance of the corresponding load device; if a value of the first device load parameter is in a positive correlation with the load capability and a value of the second device load parameter is in a negative correlation with the load capability, determining the coordinate position of each load device in the first coordinate system based on a negative number of the value of the first device load parameter corresponding to each load device and the value of the second device load parameter, the load capability being in a negative correlation with the first linear distance of the corresponding load device; or if both a value of the first device load parameter and a value of the second device load parameter are in a negative correlation with the load capability, determining the coordinate position of each load device in the first coordinate system based on the value of the first device load parameter and the value of the second device load parameter, the load capability being in a negative correlation with the first linear distance of the corresponding load device.

In some embodiments, in this embodiment, both the value of the first device load parameter and the value of the second device load parameter being in a positive correlation with the load capability may be understood as that a larger value of the first device load parameter and a larger value of the second device load parameter indicate a stronger load capability of the corresponding load device, and vice versa.

The negative number of the value of the first device load parameter and/or the negative number of the value of the second device load parameter may be understood as directly obtaining the negative number of the value of the first device load parameter and/or the negative number of the value of the second device load parameter.

There may be different correlations between device load parameters in different dimensions and load capabilities. Under the different correlations, the load capability of each load device in the first group of load devices is enumerated in a suitable manner, so that the load capability of the load device in a corresponding case may be accurately determined.

As an example solution, the device load parameter includes a first device load parameter and a second device load parameter, and the foregoing method further includes: enumerating each load device in the first group of load devices in a second coordinate system if each piece of device load information further includes a third device load parameter configured for indicating a load capability of a corresponding load device, and the third device load parameter and the first device load parameter as well as the second device load parameter all belong to different dimensions, a third coordinate axis of the second coordinate system being associated with the first device load parameter, a fourth coordinate axis of the second coordinate system being associated with the second device load parameter, and a fifth coordinate axis of the second coordinate system being associated with the third device load parameter; and determining the load capability of each load device based on a coordinate position of each load device in the second coordinate system, the load capability being related to a second linear distance of the corresponding load device, and the second linear distance being a linear distance between the coordinate position of the corresponding load device and a coordinate origin of the second coordinate system.

In some embodiments, in this embodiment, the second coordinate system may include, but is not limited to, a three-dimensional coordinate system. The third coordinate axis may be understood as an x axis of the three-dimensional coordinate system, the fourth coordinate axis may be understood as a y axis of the three-dimensional coordinate system, and the fifth coordinate axis may be understood as a z axis of the three-dimensional coordinate system. The foregoing is merely an example. This is not limited in this embodiment.

Based on the foregoing method, the load capability of each load device may be determined in the three-dimensional coordinate system, and the three-dimensional coordinate system may provide more spatial information, so that the load capability is determined more accurately and comprehensively.

As an example solution, the determining a first load device from the second group of load devices, and creating the game on the first load device includes: determining, as the first load device, a load device that is in the second group of load devices and whose load capability is at a median; and creating the game on the first load device, and transmitting a network address and a port identifier that correspond to the first load device to the first access device.

In some embodiments, in this embodiment, the determining, as the first load device, a load device that is in the second group of load devices and whose load capability is a median may be understood as determining, as the first load device, a load device that is in the second group of load devices and whose first device load parameter and second device load parameter are close after being weighted.

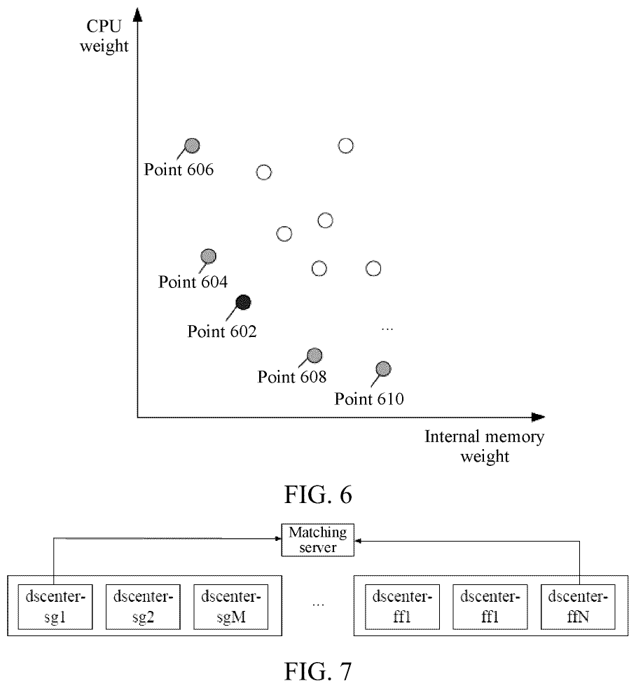

In an example embodiment, selection may be performed based on the Pareto optimality principle, and a load device with a Pareto optimality median is selected as the first load device. FIG. 6 is a schematic diagram of another example load device determining method according to an embodiment of this disclosure. As shown in FIG. 6, a point 602, a point 604, a point 606, a point 608, and a point 610 are all Pareto optimality values. Therefore, a load device represented by the point 602 at the median may be selected as a first load device for allocation in a single battle at this time.

The foregoing Pareto optimality, also referred to as Pareto efficiency, refers to an ideal state of resource allocation. It is assumed that during a change of an inherent group of people and allocatable resources from an allocation state to another state, at least one person's situation becomes better without worsening a situation of anyone else. This is Pareto improvement or Pareto optimization. A Pareto optimal state means that there is no more room for Pareto improvement. In other words, the Pareto improvement is a path and method for reaching the Pareto optimality.

A load device having a load capability at a median may mean that the load capability of the load device is neither the weakest nor the strongest. The load device is selected as the first load device for load allocation, thereby facilitating implementing balance distribution of loads in an entire load cluster.

As an example solution, the device load parameter includes a first device load parameter and a second device load parameter, and the obtaining a device load parameter corresponding to each load device in the first group of device load information includes: determining, based on a first weight parameter and a first current device load parameter that correspond to each load device, the first device load parameter corresponding to each load device in the first group of device load information, the first current device load parameter representing a device load parameter that is in a first dimension and that is reported in a latest round and corresponds to each load device, the first weight parameter representing a ratio of a device load parameter that is in the first dimension and that is reported by each load device in a historical round to a sum of device load parameters that are in the first dimension and that are reported by each load device in the historical round, the historical round representing a round previous to the latest round, the first weight parameter being set to 0 in a first round, and the first device load parameter representing a sum of the first weight parameter and the first current device load parameter; and determining, based on a second weight parameter and a second current device load parameter that correspond to each load device, the second device load parameter corresponding to each load device in the first group of device load information, the second current device load parameter representing a device load parameter that is in a second dimension and that is reported in a latest round and corresponds to each load device, the second weight parameter representing a ratio of a device load parameter that is in the second dimension and that is reported by each load device in the historical round to a sum of device load parameters that are in the second dimension and that are reported by each load device in the historical round, the second weight parameter being set to 0 in the first round, and the second device load parameter representing a sum of the second weight parameter and the second current device load parameter.

For example, when load devices need to be allocated, weights (corresponding to the foregoing device load information) are calculated for all the load devices. A manner of calculating the weight w (CPU, memory) is (a current CPU weight of the load device+a CPU idle rate reported by the load device last time, a current internal memory weight of the load device+a remaining internal memory reported by the load device last time), where initial values of the current CPU weight and the current internal memory weight of the load device are 0. After a weight update is completed on all the load devices, data of weight dimensions is inversed to make a decision. For example, (0.2, 30000) is inversed to (−0.2, −30000). Selection is performed based on the Pareto optimality principle, and a load device at a Pareto optimal median is selected.

As an example solution, the determining a first load device from the second group of load devices, and creating the game on the first load device includes: obtaining the first group of device load information by using a first device allocation process every first duration, each piece of device load information in the first group of device load information being reported in one round by the corresponding load device to a first group of device allocation processes every second duration by using a corresponding device agent process, the first device allocation process being a predetermined device allocation process in the first group of device allocation processes, and the second duration being less than the first duration; and determining the first load device from the second group of load devices by using a second device allocation process in response to the first data request, and creating the game on the first load device.

In some embodiments, in this embodiment, the foregoing first device allocation process may be understood as one of the first group of device allocation processes corresponding to the first group of load devices, and the first group of device allocation processes parallely manages the target load cluster.

The foregoing first duration is set to be greater than the second duration. In other words, a rate at which each device agent process uploads the device load information of the corresponding load device is greater than a rate at which the first device allocation process obtains the first group of device load information.

In an example embodiment, the first device allocation process may be an operating device allocation process whose sequence number is a preset value. An example in which the first device allocation process is a device allocation process having a smallest sequence number is used. FIG. 7 is a schematic diagram of another example load device determining method according to an embodiment of this disclosure. As shown in FIG. 7, an operating device allocation process (a dscenter shown in FIG. 7) that is of each load cluster and that has a smallest sequence number performs minute-level reporting, so that jitter of a load value of the entire load cluster caused by alternate reporting between different dscenters can be avoided, thereby ensuring coherence and consistency of load changes of the entire load cluster as much as possible.

As an example solution, the determining the first load device from the second group of load devices in response to the first data request by using a second device allocation process, and creating the game on the first load device includes:
transmitting a game creation instruction to the first load device by using the second device allocation process in response to the first data request, the game creation instruction being configured for instructing a device agent process corresponding to the first load device to create the game on the first load device;
performing a self-check on a load capability of the first load device in response to the game creation instruction by using the device agent process corresponding to the first load device;
when the load capability of the first load device meets a preset condition, creating the game on the first load device, and transmitting a creation success instruction to the second device allocation process, the creation success instruction being configured for notifying the second device allocation process that the first load device completes creation of the game, and the device load information including the creation success instruction; and
transmitting a creation failure instruction to the second device allocation process when the load capability of the first load device does not meet the preset condition, the creation failure instruction being configured for notifying the second device allocation process that the first load device does not complete the creation of the game, and the device load information including the creation failure instruction.

In some embodiments, in this embodiment, the second device allocation process may be understood as a device allocation process randomly selected from the first group of device allocation processes, and may be the same as or different from the first device allocation process.

The game creation instruction may be configured for indicating game content corresponding to the game created on the first load device, and the game content includes, but is not limited to, pulling a corresponding game model, and the like.

In some embodiments, in this embodiment, the foregoing device agent process corresponds to the first load device. The device agent process is configured for managing the foregoing first load device and reporting device parameter information related to the first load device to the first group of device allocation processes every second duration.

The foregoing self-check process includes a pre-battle check policy. When actually beginning a battle, the load device performs a final check on a remaining resource balance, and when the balance is insufficient, rejects to begin the battle, to ensure that the load device does not begin the battle beyond a limit, and ensure stability of the load device.

In an example solution, the foregoing method further includes the following operations: obtaining a load consumption parameter preset for the game, the load consumption parameter being configured for indicating load overheads caused by creating the game by the first load device; and if the game creation instruction is already transmitted to the first load device by using the second device allocation process and the second device allocation process does not receive the creation success instruction or the creation failure instruction, updating, based on the load consumption parameter in response to a second data request transmitted by a second access device, device load information corresponding to the first load device, to obtain updated device load information; and if the updated device load information indicates that the first load device cannot create a game again in response to the second data request, determining, based on the first group of device load information, a third group of load devices excluding the first load device, determining a second load device from the third group of load devices, and creating, on the second load device, a game corresponding to the second data request, a load capability of any load device in the third group of load devices being superior to a load capability of another load device in the first group of load devices except the third group of load devices, and load capabilities of any two load devices in the third group of load devices being not superior to each other; or if the updated device load information indicates that the first load device allows to create a game again in response to the second data request, determining a fourth group of load devices based on the first group of device load information and the load consumption parameter, determining a second load device from the fourth group of load devices, and creating, on the second load device, a game corresponding to the second data request, a load capability of any load device in the fourth group of load devices being superior to a load capability of another load device in the first group of load devices except the fourth group of load devices, and load capabilities of any two load devices in the fourth group of load devices being not superior to each other.

In some embodiments, in this embodiment, the foregoing load consumption parameter may be understood as follows: According to empirical values of different types of games, by pre-withholding a remaining allocatable internal memory and port in a current reporting period, a load device whose resource is completely allocated is removed in advance, and the game is allocated to a more idle load device.

In an example embodiment, the obtaining a preset load consumption parameter is to indicate load overheads generated when the first load device creates the game. For example, if a game requires a large quantity of computation and graphic processing, the load consumption parameter may be represented as required CPU and GPU resources.

When the second device allocation process transmits the game creation instruction to the load device, if the second device allocation process does not receive the creation success or failure instruction, device load information corresponding to the first load device needs to be updated based on the load consumption parameter.

If the updated device load information indicates that the first load device cannot respond to the second data request again or create the game, the third group of load devices excluding the first load device may be determined based on the first group of device load information. Then, the second load device is selected from the third group of load devices, and a game corresponding to the second data request is created on the second load device. A load capability of any load device in the third group of load devices is superior to that of another load device in the first group of load devices except the third group of load devices. In addition, load capabilities of any two load devices in the third group of load devices are not superior to each other.

If the updated device load information indicates that the first load device may continue responding to the second data request and create the game, the fourth group of load devices may be determined based on the first group of device load information and the load consumption parameter. Then, the second load device is selected from the fourth group of load devices, and the game corresponding to the second data request is created on the second load device. A load capability of any load device in the fourth group of load devices is superior to that of another load device in the first group of load devices except the fourth group of load devices. In addition, load capabilities of any two load devices in the fourth group of load devices are not superior to each other.

In conclusion, based on the preset load consumption parameter and the device load information, a suitable load device may be selected to create the game, to ensure optimal performance and load balancing.

For example, for a game that is allocated to a matching server and whose actual battle beginning is not reported and confirmed by a dsagent, a dscenter records the game and occupies a pre-withheld resource. For a game that is not confirmed after, for example, more than five reporting periods, the dscenter considers that the battle beginning fails, and releases the pre-withheld resource occupied by the dscenter. A plurality of parallel dscenters all ensure, based on the foregoing pre-withholding policy, that the dscenters do not perform overallocation, thereby ensuring allocation stability and quality of an entire cluster.

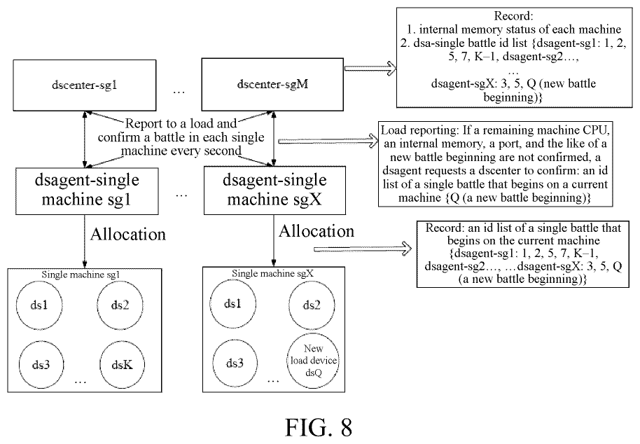

FIG. 8 is a schematic diagram of another example load device determining method according to an embodiment of this disclosure. As shown in FIG. 8, each load cluster has a plurality of parallel dscenters, and any dscenter may allocate a single battle to any dsagent. For example, a load cluster has M dscenters and X dsagents, and each dscenter receives a report from each of the X dsagents and allocates a single battle to load devices managed by the X dsagents. Each dscenter records a CPU idle rate, an internal memory balance, and a single-battle available port balance of a load device managed by each dsagent. Because the dsagent reports load information every second, load information of the load device managed by each dsagent in the dscenter is also updated every second. The dscenter needs to perform allocation each time by using a proper load balancing policy. However, in each load cluster, load information of each load device is reported by the dsagent to the dscenter in seconds. The dsagent reports the CPU idle rate, the internal memory balance, and the single-battle available port balance of the managed load device, and a newly added single battle that is not currently confirmed by a corresponding dscenter. After the dscenter confirms the newly added single battle within the current reporting period, the dsagent does not need to carry information of a confirmed single battle during next reporting. A processing manner of ending the single battle in the current reporting period is similar to that of a new single battle. In an example solution, the foregoing method further includes the following operations: obtaining a total quantity of device allocation processes of the first group of device allocation processes; determining a first load threshold and a second load threshold based on the first device load parameter, the second device load parameter, and the total quantity of device allocation processes, the first load threshold representing a ratio of the first device load parameter to the total quantity of device allocation processes, and the second load threshold representing a ratio of the second device load parameter to the total quantity of device allocation processes; and determining, in response to the first data request based on the first load threshold and the second load threshold, the second group of load devices allowed to be allocated by the second device allocation process in a current round, the first device load parameter corresponding to each load device in the second group of load devices being less than or equal to the first load threshold, and the second device load parameter being less than or equal to the second load threshold.

In some embodiments, in this embodiment, the first load threshold and the second load threshold may be understood as a maximum load allowed to be allocated by one device allocation process. In other words, when a load of a load device is less than the load threshold, the load device certainly does not belong to the second group of load devices.

For example, to prevent impact on all ongoing single battles or a failure of beginnings of new single battles due to OOM of a load device caused by a huge battle beginning allocation quantity entering the load device within a load reporting update period, a pre-withholding policy is provided. According to empirical values of different types of single battles, a remaining allocatable internal memory and port in the current reporting period is pre-withheld, a load device whose resource is completely allocated is removed in advance, and the single battle is allocated to a more idle load device, thereby ensuring stability and quality of a beginning of a subsequent single battle. For example, a load cluster has M dscenters, and a dsagent reports that an idle internal memory and a port of the dscenter are x and y. In this case, the dscenter can allocate only an internal memory and a port of x/M and y/M this time. When the dsagent performs reporting next time, the dscenter updates a balance.

As an example solution, the determining a target load cluster based on network parameters between the first access device and a plurality of load clusters in response to the first data request includes: arranging the plurality of load clusters based on response speeds and the network parameters between the first access device and the plurality of load clusters, to obtain a target load cluster set; selecting a load cluster with a highest response speed from the target load cluster set each time, and determining a cluster load capability of the selected load cluster; and deleting the selected load cluster from the target load cluster set when the cluster load capability does not meet a preset load condition; or determining the selected load cluster as the target load cluster when the cluster load capability meets a preset load condition.

This disclosure is further described below with reference to specific examples.

This disclosure mainly provides a global same-server game matching solution, mainly including the following content:
(1) A high-performance load cluster allocation solution is provided, and acts on an entire allocation procedure. A database does not need to be queried during the entire load device allocation procedure, and allocation can be quickly completed within a short time.
(2) A solution for increasing resource utilization of a load device in a load cluster is provided.
(3) A load reporting and incremental synchronization mechanism is provided, to ensure that loads of the load devices are accurately and reliably updated, thereby avoiding an online major accident caused by problems such as an unreliable load device status update due to a reporting time sequence problem and overflowing of an internal memory caused by allocation overload of the load devices.
(4) A load allocation algorithm is provided. By means of a multi-level pre-withholding mechanism and a load balancing policy, sharp changes that are in indicators such as a CPU and an internal memory of a machine and that are caused by a large quantity of battle beginnings rushing into the one machine within a short time are prevented, thereby ensuring stable single-battle allocation and reducing a battle beginning failure rate.

A multi-load cluster allocation solution for global games that is provided in a related technology generally uses a random routing policy, to evenly allocate battles to load devices in a quantity dimension. After a battle beginning request arrives at a matching server, after a cluster dscenter is selected based on a player, a dsagent is selected by using a random algorithm, to create a single battle.

It can be seen from the foregoing analysis that there are relatively many problems when the foregoing technical solution is directly used, and complete balancing may not be implemented by using the random algorithm. There may be a relatively small quantity of battle beginnings and low resource utilization on some load devices. In some examples, an excessively large quantity of single battles may be randomly distributed to the same load device at a time point, thereby causing a battle beginning failure and even causing OOM to affect all single battles on an entire machine. Based on this disclosure, various problems existing in a load cluster random routing allocation solution are resolved.

For a global same-server game, matching needs to be performed based on network delays of players, and players with the same network delay condition are matched to the same single battle, to protect game fairness and experience of the players. For a single battle, it is crucial to allocate the single battle to a load cluster whose network delay is as low as possible and that has a remaining capacity.

Because there are a plurality of load clusters globally, a plurality of machines exist in one load cluster. Because most games have a plurality of different maps, modes, and playing methods, various machine resources consumed by each single battle are different, and actual load balancing cannot be implemented by allocating single battles to different load devices based only on a quantity of single battles. Therefore, a set of solutions is required to resolve various types of load balancing of a machine.

To increase battle beginning efficiency and avoid frequent database read and write in a single-battle allocation process, a more efficient allocation policy needs to be used. To ensure that an allocation process is reliable, and prevent a single-battle beginning failure after allocation, a reliable mechanism further needs to be designed to ensure allocation rationality.

To resolve various problems of a random routing allocation solution of a load cluster and implement efficient and high-quality full-load cluster allocation, a global game load cluster allocation solution with load balancing is provided.

For a global same-server FPS game with a high PCU, to improve battle experience of players and machines, load clusters are deployed in a plurality of regions around the world. Each load cluster includes a plurality of load devices. A single battle in which a player is actually successfully matched is performed on a load device, and the load device needs to ensure a delay as low as possible for each player. Because a large quantity of load devices of the plurality of load clusters have relatively high costs, proper planning and deployment need to be performed, to increase utilization of the load devices as much as possible.

This solution is also applicable to another global same-server matching game that has a high PCU, has a high requirement on a real-time operation, and needs to perform load cluster allocation.

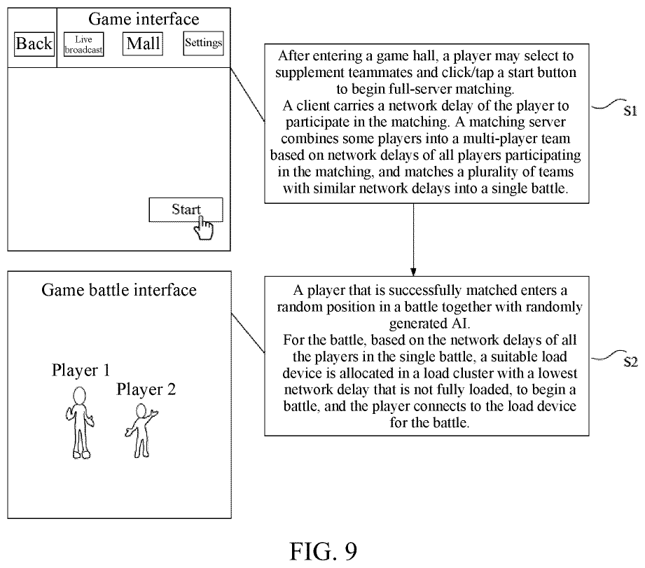

The following is descriptions of an application scenario of the current solution in the game. FIG. 9 is a schematic diagram of another example load device determining method according to an embodiment of this disclosure. As shown in FIG. 9, this disclosure includes, but is not limited to, the following operations.
S1: After entering a game hall, a player may select to supplement teammates and click/tap a beginning button to begin full-server matching. A client carries a network delay of the player to participate in the matching. A matching server combines some players into a multi-player team based on network delays of all players participating in the matching, and matches a plurality of teams with similar network delays into a single battle.
S2: A player that is successfully matched enters a random position in a battle together with randomly generated AI. For the battle, based on the network delays of all the players in the single battle, a suitable load device is allocated in a load cluster with a lowest network delay that is not fully loaded, to begin a battle, and the player connects to the load device for the battle.

Based on the foregoing descriptions, in the technical solution of this disclosure, after the player initiates a matching request, the matching server performs matching on network delays of global players. Generally, players whose network delays of load clusters in different regions are relatively close are allocated to a single battle. For example, in a single battle, network delay ranges of 10 players for five load clusters A, B, C, D, and E are respectively [110 to 120], [30 to 40], [60 to 80], [140 to 160], and [210 to 220] (unit: millisecond). After successfully matching players to enter a single battle, the matching server requests to perform allocation to the single battle. In this case, if the load cluster B is not fully loaded, the matching server requests the load cluster B to perform allocation to the single battle. When the load cluster B is fully loaded, the matching server sequentially attempts to perform allocation to a single battle from a load cluster that is not fully loaded among the load clusters C, A, D, and E.

A plurality of load clusters are deployed globally. Therefore, an example of the five load clusters A, B, C, D, and E is used. The five load clusters each have several parallel dscenters to manage the entire cluster together, and each cluster also has several dsagents to separately manage each load device in the cluster.

An operating dscenter that is of each load cluster and that has a smallest sequence number performs minute-level reporting, so that jitter of a load value of the entire load cluster caused by alternate reporting between different dscenters can be avoided, thereby ensuring consistency of load changes of the entire load cluster as much as possible. The dscenter having the smallest sequence number is selected.

A load balancing solution in a cluster mainly includes a load reporting and incremental synchronization mechanism, a load balancing allocation policy, a pre-withholding policy, and a pre-battle check policy.

Load reporting and incremental synchronization mechanism: In each load cluster, load information of each load device is reported by a dsagent to a dscenter in seconds. The dsagent reports a CPU idle rate, an internal memory balance, and a single-battle available port balance of the managed load device, and a newly added single battle that is not currently confirmed by a corresponding dscenter. After the dscenter confirms the newly added single battle within the current reporting period, the dsagent does not need to carry information of a confirmed single battle during next reporting. A processing manner of ending the single battle in the current reporting period is similar to that of a new single battle.

Load balancing allocation policy: Each load cluster has a plurality of parallel dscenters, and any dscenter may allocate a single battle to any dsagent. For example, the load cluster B has M dscenters and X dsagents, and each dscenter receives a report from each of the X dsagents and allocates a single battle to load devices managed by the X dsagents. Each dscenter records a CPU idle rate, an internal memory balance, and a single-battle available port balance of a load device managed by each dsagent. Because the dsagent reports load information every second, load information of the load device managed by each dsagent in the dscenter is also updated every second. The dscenter needs to perform allocation each time by using a proper load balancing policy. When a dscenter performs allocation, weights are calculated for all load devices. A manner of calculating the weight w (CPU, memory) is (a current CPU weight of the load device+a CPU idle rate reported by the load device last time, a current internal memory weight of the load device+a remaining internal memory reported by the load device last time), where initial values of the current CPU weight and the current internal memory weight of the load device are 0. After a weight update is completed on all the load devices, data of weight dimensions is inversed to make a decision. For example, (0.2, 30000) is inversed to (−0.2, −30000). Selection is performed based on the Pareto optimality principle, and a load device at a Pareto optimal median is selected.

Pre-withholding policy: To prevent impact on all ongoing single battles or a failure of beginnings of new single battles due to OOM of a load device caused by a huge battle beginning allocation quantity entering the load device within a load reporting update period, the pre-withholding policy is provided. According to empirical values of different types of single battles, a remaining allocatable internal memory and port in the current reporting period is pre-withheld, a load device whose resource is completely allocated is removed in advance, and the single battle is allocated to a more idle load device, thereby ensuring stability and quality of a beginning of a subsequent single battle. For example, the load cluster B has M dscenters, and a dsagent reports that an idle internal memory and a port of the dscenter are x and y. In this case, the dscenter can allocate only an internal memory and a port of x/M and y/M this time. When the dsagent performs reporting next time, the dscenter updates a balance. For a single battle that is allocated to a matching server and whose actual battle beginning is not reported and confirmed by a dsagent, a dscenter records the battle and occupies a pre-withheld resource. For a single battle that is not confirmed after, for example, more than five reporting periods, the dscenter considers that the battle beginning fails, and releases the pre-withheld resource occupied by the dscenter. A plurality of parallel dscenters all ensure, based on the foregoing pre-withholding policy, that the dscenters do not perform overallocation, thereby ensuring allocation stability and quality of an entire cluster.

Pre-battle check policy: When actually beginning a battle, the load device performs a final check on a remaining resource balance, and when the balance is insufficient, rejects to begin the battle, to ensure that the load device does not begin the battle beyond a limit, and ensure stability of the load device.

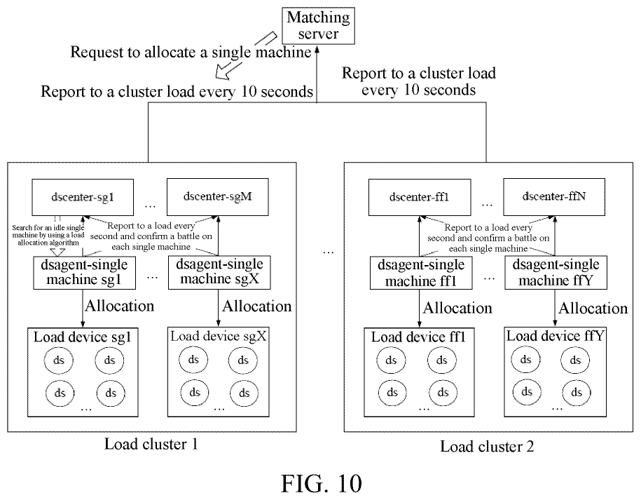

FIG. 10 is a schematic diagram of another example load device determining method according to an embodiment of this disclosure. As shown in FIG. 10, a well-developed global game load cluster distribution solution with load balancing is formed based on the foregoing load balancing solution between clusters (a load cluster 1 and a load cluster 2) and a plurality of policies of the load balancing solution inside the cluster, and the entire solution is divided into reporting and distribution. Load information is updated periodically based on a plurality of policies inside a reporting procedure, and a most suitable load device is allocated based on the load information in an allocation procedure.

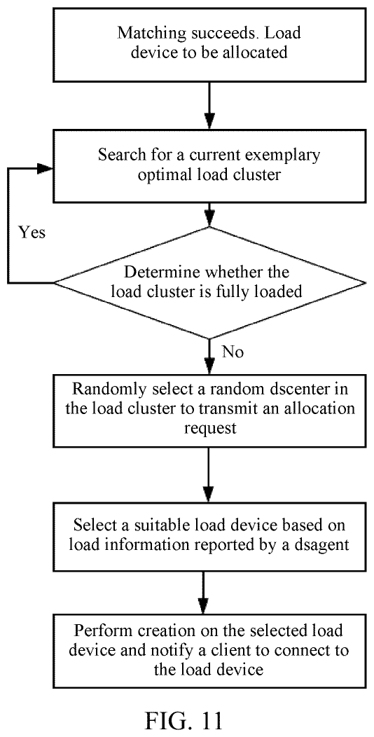

FIG. 11 is a schematic diagram of another example load device determining method according to an embodiment of this disclosure. As shown in FIG. 11, after matching succeeds, a current example optimal load cluster, for example, a load cluster B, is searched for. If the load cluster B is fully loaded, sub-optimal C, A, D, and E are selected in sequence. If the load cluster B is not fully loaded, a dscenter is randomly selected from the current load cluster to transmit a load device allocation request. The dscenter selects a load device based on load information of the load device reported by a plurality of dsagents, creates a single battle, and notifies a client of an IP and a port of the load device. The client connects to the load device to begin a battle between players.

By using this solution, when a single battle is limited to 200 battle beginnings, a remaining warning value of a CPU of 20%, and a remaining warning value of an internal memory of 10 G, for a current application, results that are of a battle beginning success rate and stability of load devices in a load cluster and that are obtained by performing a plurality of groups of repeated stress tests on 150 load devices in a single load cluster at different battle beginning speeds are shown in Table 1.

Based on this embodiment, utilization of load devices in a load cluster may be apparently increased, and machine costs can be reduced. Stability of the load device may also be apparently improved, and a service may be prevented from being affected by a large quantity of traffic peak values. In addition, a relatively high single-battle allocation speed may further be ensured, and load balancing during load cluster allocation can be ensured by avoiding performing a large quantity of operations on the database.

TABLE 1
Overall effect of this solution

| Battle | | Solution | Random |
|---|---|---|---|
| beginning | | in this | routing |
| speed | Indicator | disclosure | solution |
| 350 battle | Battle beginning success | 99.8% to 100% | 20% to 25% |
| beginnings | rate of a single battle | | |
| per second | Load device stability | 100% | 28% to 37% |
| 200 battle | Battle beginning success | 100% | 35% to 40% |
| beginnings | rate of a single battle | | |
| per second | Load device stability | 100% | 64% to 71% |
| 50 battle | Battle beginning success | 100% | 80% to 88% |
| beginnings | rate of a single battle | | |
| per second | Load device stability | 100% | 95% to 97% |

In this solution, a manner of reliable reporting and confirmation with relatively high performance is used. For example, an excessively large machine size of a cluster and a large quantity of load devices cause a sharply reduced performance of a reporting and confirmation feedback mechanism. Allocation reliability of a load cluster may be ensured in a manner, for example, redis, thereby ensuring allocation performance. If actually required, more diversified indicators in addition to indicators such as a CPU, an internal memory, a port, and a single-battle quantity may be added for evaluation of resource utilization of the entire load cluster and the load device, to implement a stricter and more diversified limitation.

In the implementations of this disclosure, relevant data such as user information is involved. When the foregoing embodiments of this disclosure are applied to a specific product or technology, a permission or consent of a user is required, and collection, use, and processing of the relevant data need to comply with relevant laws, regulations, and standards of relevant countries and regions.

For ease of description, the foregoing method embodiments are described as a series of action combinations. However, it is noted that this disclosure is not limited to the described order of the actions because some operations may be performed in another order or performed at the same time based on this disclosure. In addition, it is noted that the embodiments described in this specification are all example embodiments, and the involved actions and modules are not necessarily required to this disclosure.

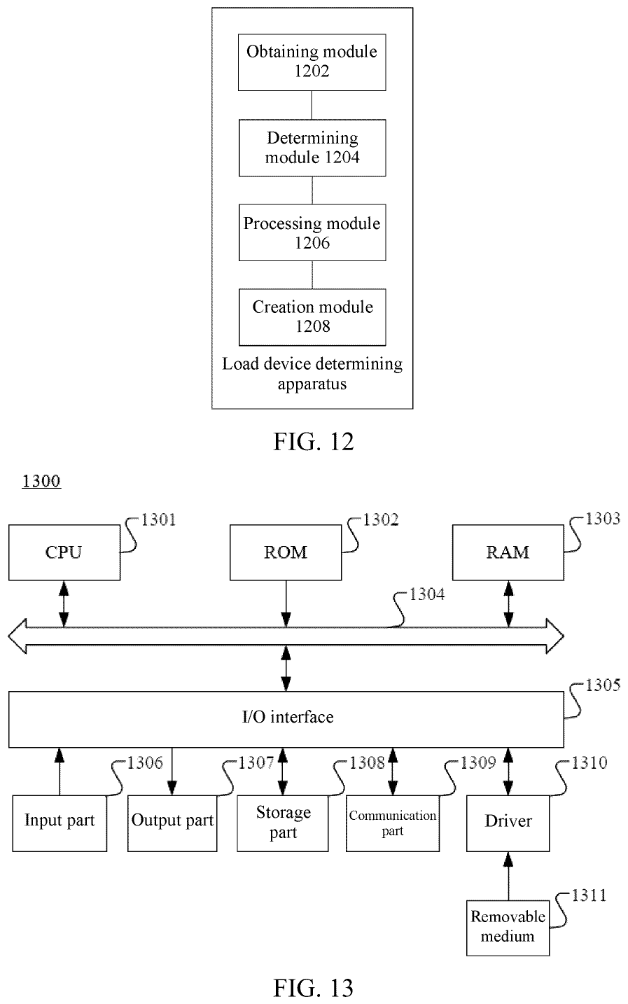

According to another aspect of the embodiments of this disclosure, a load device determining apparatus for implementing the foregoing load device determining method is further provided. As shown in FIG. 12, the apparatus includes: an obtaining module 1202, configured to obtain a first data request transmitted by a first access device, the first data request being configured for requesting to begin a game in a current application; a determining module 1204, configured to determine a target load cluster based on network parameters between the first access device and a plurality of load clusters in response to the first data request, the target load cluster being a load cluster that is among the plurality of load clusters and whose network parameter meets a preset network parameter condition; a processing module 1206, configured to determine a second group of load devices from a first group of load devices based on a first group of device load information reported by the first group of load devices in the target load cluster, each piece of device load information in the first group of device load information including a device load parameter configured for indicating a load capability of a corresponding load device in different dimensions, a load capability of any load device in the second group of load devices being superior to a load capability of another load device in the first group of load devices except the second group of load devices, and load capabilities of any two load devices in the second group of load devices being not superior to each other; and a creation module 1208, configured to determine a first load device from the second group of load devices, and create the game on the first load device.

As an example solution, the apparatus is configured to determine the second group of load devices from the first group of load devices in the following manner based on the first group of device load information reported by the first group of load devices in the target load cluster: obtaining a device load parameter corresponding to each load device in the first group of device load information; determining a load capability of each load device in the first group of load devices based on the device load parameter by using an enumeration method; and determining the second group of load devices based on the load capability of each load device.

As an example solution, the device load parameter includes a first device load parameter and a second device load parameter, and the apparatus being configured to determine the load capability of each load device in the first group of load devices in the following manner based on the device load parameter by using the enumeration method includes: enumerating each load device in the first group of load devices in a first coordinate system, a first coordinate axis of the first coordinate system being associated with the first device load parameter, and a second coordinate axis of the first coordinate system being associated with the second device load parameter; and determining the load capability of each load device based on a coordinate position of each load device in the first coordinate system, the load capability being related to a first linear distance of a corresponding load device, and the first linear distance being a linear distance between the coordinate position of the corresponding load device and a coordinate origin of the first coordinate system.

As an example solution, the apparatus being configured to enumerate each load device in the first group of load devices in the first coordinate system in the following manner includes: if both a value of the first device load parameter and a value of the second device load parameter are in a positive correlation with the load capability, determining the coordinate position of each load device in the first coordinate system based on a negative number of the value of the first device load parameter corresponding to each load device and a negative number of the value of the second device load parameter, the load capability being in a negative correlation with the first linear distance of the corresponding load device; if a value of the first device load parameter is in a positive correlation with the load capability and a value of the second device load parameter is in a negative correlation with the load capability, determining the coordinate position of each load device in the first coordinate system based on a negative number of the value of the first device load parameter corresponding to each load device and the value of the second device load parameter, the load capability being in a negative correlation with the first linear distance of the corresponding load device; or if both a value of the first device load parameter and a value of the second device load parameter are in a negative correlation with the load capability, determining the coordinate position of each load device in the first coordinate system based on the value of the first device load parameter and the value of the second device load parameter, the load capability being in a negative correlation with the first linear distance of the corresponding load device.

As an example solution, the device load parameter includes a first device load parameter and a second device load parameter, and the apparatus is further configured to: enumerate each load device in the first group of load devices in a second coordinate system if each piece of device load information further includes a third device load parameter configured for indicating a load capability of a corresponding load device, and the third device load parameter and the first device load parameter as well as the second device load parameter all belong to different dimensions, a third coordinate axis of the second coordinate system being associated with the first device load parameter, a fourth coordinate axis of the second coordinate system being associated with the second device load parameter, and a fifth coordinate axis of the second coordinate system being associated with the third device load parameter; and determine the load capability of each load device based on a coordinate position of each load device in the second coordinate system, the load capability being related to a second linear distance of a corresponding load device, and the second linear distance being a linear distance between the coordinate position of the corresponding load device and a coordinate origin of the second coordinate system.

As an example solution, the apparatus is configured to determine the first load device from the second group of load devices in the following manner, and create the game on the first load device: determining, as the first load device, a load device that is in the second group of load devices and whose load capability is at a median; and creating the game on the first load device, and transmitting a network address and a port identifier that correspond to the first load device to the first access device.

As an example solution, the device load parameter includes a first device load parameter and a second device load parameter, and the apparatus is configured to obtain, in the following manner, the device load parameter corresponding to each load device in the first group of device load information: determining, based on a first weight parameter and a first current device load parameter that correspond to each load device, the first device load parameter corresponding to each load device in the first group of device load information, the first current device load parameter representing a device load parameter that is in a first dimension and that is reported in a latest round and corresponds to each load device, the first weight parameter representing a ratio of a device load parameter that is in the first dimension and that is reported by each load device in a historical round to a sum of device load parameters that are in the first dimension and that are reported by each load device in the historical round, the historical round representing a round previous to the latest round, the first weight parameter being set to 0 in a first round, and the first device load parameter representing a sum of the first weight parameter and the first current device load parameter; and determining, based on a second weight parameter and a second current device load parameter that correspond to each load device, the second device load parameter corresponding to each load device in the first group of device load information, the second current device load parameter representing a device load parameter that is in a second dimension and that is reported in a latest round and corresponds to each load device, the second weight parameter representing a ratio of a device load parameter that is in the second dimension and that is reported by each load device in the historical round to a sum of device load parameters that are in the second dimension and that are reported by each load device in the historical round, the second weight parameter being set to 0 in the first round, and the second device load parameter representing a sum of the second weight parameter and the second current device load parameter.

As an example solution, the apparatus is configured to determine the first load device from the second group of load devices in the following manner, and create the game on the first load device: obtaining the first group of device load information by using a first device allocation process every first duration, each piece of device load information in the first group of device load information being reported in one round by the corresponding load device to a first group of device allocation processes every second duration by using a corresponding device agent process, the first device allocation process being a predetermined device allocation process in the first group of device allocation processes, and the second duration being less than the first duration; and determining the first load device from the second group of load devices by using a second device allocation process in response to the first data request, and creating the game on the first load device.

As an example solution, the apparatus is configured to determine the first load device from the second group of load devices by using the second device allocation process in response to the first data request in the following manner, and create the game on the first load device: transmitting a game creation instruction to the first load device by using the second device allocation process in response to the first data request, the game creation instruction being configured for instructing a device agent process corresponding to the first load device to create the game on the first load device; performing a self-check on a load capability of the first load device in response to the game creation instruction by using the device agent process corresponding to the first load device; when the load capability of the first load device meets a preset condition, creating the game on the first load device, and transmitting a creation success instruction to the second device allocation process, the creation success instruction being configured for notifying the second device allocation process that the first load device completes creation of the game, and the device load information including the creation success instruction; and transmitting a creation failure instruction to the second device allocation process when the load capability of the first load device does not meet the preset condition, the creation failure instruction being configured for notifying the second device allocation process that the first load device does not complete the creation of the game, and the device load information including the creation failure instruction.

As an example solution, the apparatus is further configured to: obtain a load consumption parameter preset for the game, the load consumption parameter being configured for indicating load overheads caused by creating the game by the first load device; and if the game creation instruction is already transmitted to the first load device by using the second device allocation process and the second device allocation process does not receive the creation success instruction or the creation failure instruction, update, based on the load consumption parameter in response to a second data request transmitted by a second access device, device load information corresponding to the first load device, to obtain updated device load information; and if the updated device load information indicates that the first load device cannot create a game again in response to the second data request, determine, based on the first group of device load information, a third group of load devices excluding the first load device, determine a second load device from the third group of load devices, and create, on the second load device, a game corresponding to the second data request, a load capability of any load device in the third group of load devices being superior to a load capability of another load device in the first group of load devices except the third group of load devices, and load capabilities of any two load devices in the third group of load devices being not superior to each other; or if the updated device load information indicates that the first load device allows to create a game again in response to the second data request, determine a fourth group of load devices based on the first group of device load information and the load consumption parameter, determine a second load device from the fourth group of load devices, and create, on the second load device, a game corresponding to the second data request, a load capability of any load device in the fourth group of load devices being superior to a load capability of another load device in the first group of load devices except the fourth group of load devices, and load capabilities of any two load devices in the fourth group of load devices being not superior to each other.

As an example solution, the device load parameter includes a first device load parameter and a second device load parameter, and the apparatus is further configured to: obtain a total quantity of device allocation processes of the first group of device allocation processes; determine a first load threshold and a second load threshold based on the first device load parameter, the second device load parameter, and the total quantity of device allocation processes, the first load threshold representing a ratio of the first device load parameter to the total quantity of device allocation processes, and the second load threshold representing a ratio of the second device load parameter to the total quantity of device allocation processes; and determine, in response to the first data request based on the first load threshold and the second load threshold, the second group of load devices allowed to be allocated by the second device allocation process in a current round, the first device load parameter corresponding to each load device in the second group of load devices being less than or equal to the first load threshold, and the second device load parameter being less than or equal to the second load threshold.

As an example solution, the apparatus is configured to determine the target load cluster based on the network parameters between the first access device and the plurality of load clusters in response to the first data request in the following manner: arranging the plurality of load clusters based on response speeds and the network parameters between the first access device and the plurality of load clusters, to obtain a target load cluster set; selecting a load cluster with a highest response speed from the target load cluster set each time, and determining a cluster load capability of the selected load cluster; and deleting the selected load cluster from the target load cluster set when the cluster load capability does not meet a preset load condition; or determining the selected load cluster as the target load cluster when the cluster load capability meets a preset load condition.

With regard to the apparatus in the above-mentioned embodiments, specific manners of performing operations by each module are described in detail in the embodiments related to the method. This is not described in detail herein.

According to one aspect of this disclosure, a computer program product is provided, including a computer program, the computer program including program code configured for performing the methods shown in the flowcharts. In such an embodiment, the computer program may be downloaded and installed from a network through a communication part 1309, and/or installed from a removable medium 1311. When the computer program is executed by a central processing unit 1301, various functions provided in embodiments of this disclosure are executed.

The sequence numbers of the foregoing embodiments of this disclosure are merely for description purpose but do not imply the preference among the embodiments.

FIG. 13 is a block diagram of a structure of a computer system of an electronic device for implementing the embodiments of this disclosure.

The computer system 1300 of the electronic device shown in FIG. 13 is merely an example, and does not constitute any limitation on functions and use ranges of the embodiments of this disclosure.

As shown in FIG. 13, the computer system 1300 includes a central processing unit (CPU) 1301, which may execute various proper actions and processing based on a program stored in a read-only memory (ROM) 1302 or a program loaded from a storage part 1308 into a random access memory (RAM) 1303. The random access memory 1303 further stores various programs and data required by system operations. The central processing unit 1301, the read-only memory 1302, and the random access memory 1303 are connected to each other through a bus 1304. An input/output (I/O) interface 1305 is also connected to the bus 1304.

The following components are connected to the input/output interface 1305: an input part 1306 including a keyboard, a mouse, and the like; an output part 1307 including a cathode ray tube (CRT), a liquid crystal display (LCD), a speaker, and the like; the storage part 1308 including hard disk, and the like; and a communication part 1309 including a network interface card such as a local area network card or a modem. The communication part 1309 performs communication processing by using a network such as the Internet. A driver 1310 is also connected to the input/output interface 1305 as required. A removable medium 1311, such as a magnetic disk, an optical disc, a magneto-optical disk, or a semiconductor memory, is installed on the drive 1310 as required, so that a computer program read from the removable medium is installed into the storage part 1308 as required.

Particularly, based on the embodiments of this disclosure, the processes described in the various method flowcharts may be implemented as computer software programs. For example, this embodiment of this disclosure includes a computer program product, the computer program product includes a computer program carried on a computer-readable medium, and the computer program includes program code configured for performing the methods shown in the flowcharts. In such an embodiment, the computer program may be downloaded and installed from a network through the communication part 1309, and/or installed from the removable medium 1311. When the computer program is executed by the central processing unit 1301, various functions defined in the system of this disclosure are performed.

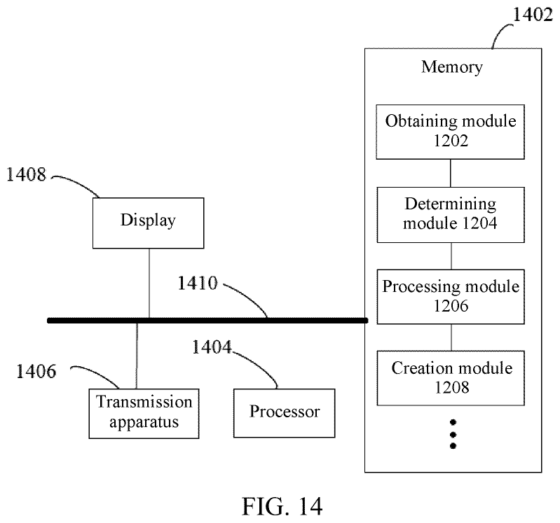

According to another aspect of the embodiments of this disclosure, an electronic device configured to implement the foregoing load device determining method is further provided. The electronic device may be the terminal device or the server shown in FIG. 1. This embodiment is described by using an example in which the electronic device is a terminal device. As shown in FIG. 14, the electronic device includes a memory 1402 and a processor 1404. The memory 1402 has a computer program stored therein, and the processor 1404 is configured to perform operations in any one of the foregoing method embodiments by using the computer program.

In some embodiments, in this embodiment, the foregoing electronic device may be located in at least one of a plurality of network devices in a computer network.

In some embodiments, in this embodiment, the processor may be configured to perform, by using the computer program, the load device determining method described in the foregoing embodiments.

In some embodiments, it is noted that, the structure shown in FIG. 14 is only schematic. The electronic device may be a terminal device such as a smartphone (such as an Android mobile phone or an iOS mobile phone), a tablet computer, a palmtop computer, a mobile Internet device (MID), or a PAD. FIG. 14 does not limit the structure of the electronic device. For example, the electronic device may further include more or fewer components (such as a network interface) than those shown in FIG. 14, or have a configuration different from that shown in FIG. 14.

The memory 1402 may be configured to store a software program and a module, such as program instructions/modules corresponding to the load device determining method and apparatus in the embodiments of this disclosure. The processor 1404 executes various functional applications and data processing by running the software program and the module stored in the memory 1402, that is, implements the foregoing load device determining method. The memory 1402 may include a high-speed random memory, and may further include a non-volatile memory, for example, one or more magnetic storage apparatuses, a flash memory, or another nonvolatile solid-state memory. In some embodiments, the memory 1402 may further include memories remotely disposed relative to the processor 1404, and these remote memories may be connected to the terminal device through a network. Examples of the network include, but are not limited to, the Internet, an intranet, a local area network, a mobile communication network, and a combination thereof. The memory 1402 may be configured to store information such as a load device parameter. This is not limited. As an example, as shown in FIG. 14, the memory 1402 may include, but is not limited to, the obtaining module 1202, the determining module 1204, the processing module 1206, and the creation module 1208 in the foregoing load device determining apparatus. In addition, the memory 1402 may further include, but is not limited to, other modules and units in the foregoing load device determining apparatus. Details are not described again in this example.

In some embodiments, a transmission apparatus 1406 is configured to receive or transmit data through a network. Specific instances of the foregoing network may include a wired network and a wireless network. In an example, the transmission apparatus 1406 includes a network interface controller (NIC). The NIC may be connected to another network device and a router by using a network cable, to communicate with the Internet or a local area network. In an example, the transmission apparatus 1406 is a radio frequency (RF) module, and is configured to communicate with the Internet in a wireless manner.

In addition, the electronic device further includes: a display 1408, configured to display the foregoing game; and a connection bus 1410, configured to connect various module components in the foregoing electronic device.

In another embodiment, the foregoing terminal device or server may be a node in a distributed system. The distributed system may be a blockchain system, and the blockchain system may be a distributed system formed by connecting a plurality of nodes through network communication. A point-to-point network may be formed between the nodes. A computing device in any form, for example, an electronic device such as a server or a terminal device, may become a node in the blockchain system by joining the point-to-point network.

According to an aspect of this disclosure, a computer-readable storage medium is provided. A processor of a computer device reads a computer program from the computer-readable storage medium, and executes the computer program, so that the computer device performs the load device determining method provided in the various example implementations of the load device determining aspects.

In some embodiments, in this embodiment, it is noted that, all or some operations in the methods of the foregoing embodiments may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

The sequence numbers of the foregoing embodiments of this disclosure are merely for description purpose but do not imply the preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a PC, a server, a network device or the like) to perform all or some of the operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, it is to be understood that, the disclosed client may be implemented in another manner. The apparatus embodiments described above are some examples. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected based on actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of load device determination, comprising:
obtaining a first data request that is transmitted by a first access device, the first data request requesting to begin a game in a current application;
determining a target load cluster based on network parameters between the first access device and a plurality of load clusters, the target load cluster being a load cluster in the plurality of load clusters and satisfying a preset network parameter condition, the target load cluster comprising a first group of load devices;
determining a second group of load devices from the first group of load devices based on respective device load information of the first group of load devices,
device load information of a load device in the first group of load devices comprising a plurality of device load parameters in a plurality of dimensions that indicates a load capability for the load device,
the second group of load devices being a first subset of the first group of load devices,
the first group of load devices including the first subset and a second subset, the second subset including load devices of the first group of load devices that are not in the first subset,
for each second load device in the second subset, the first subset including at least a first load device with a first load capability superior to the second load device, and
load capabilities of each pair of first load devices in the first subset being not superior to each other;
selecting a target first load device from the first subset; and
creating the game on the target first load device.

2. The method according to claim 1, wherein the determining the second group of load devices comprises:
obtaining respective plurality of device load parameters for the first group of load devices, a plurality of device load parameters being obtained for each load device in the first group of load devices;
determining respective load capabilities of the first group of load devices, a load capacity being determined for each load device in the first group of load devices; and
determining the first subset based on the respective load capabilities of the first group of load devices.

3. The method according to claim 2, wherein the plurality of device load parameters for each load device comprises a first device load parameter and a second device load parameter, and the determining the respective load capabilities comprises:
enumerating the first group of load devices in a first coordinate system, the first coordinate system comprising a first coordinate axis being associated with first device load parameters of load devices in the first group of load devices, and a second coordinate axis being associated with second device load parameters of the load devices in the first group of load devices; and
determining a load capability of a load device in the first group of load devices based on a coordinate position of the load device in the first coordinate system, the load capability being related to a first linear distance between the coordinate position of the load device and a coordinate origin of the first coordinate system.

4. The method according to claim 3, wherein the enumerating the first group of load devices comprises:
when both a first device load parameter of a load device in the first group of load devices and a second device load parameter of the load device are in a positive correlation with a load capability of the load device, determining a coordinate position of the load device in the first coordinate system based on a negative value of the first device load parameter of the load device and a negative value of the second device load parameter of the load device, the load capability of the load device being in a negative correlation with a first linear distance of the load device.

5. The method according to claim 3, wherein the enumerating the first group of load devices comprises:
when a first device load parameter of a load device in the first group of load devices is in a positive correlation with a load capability of the load device and a second device load parameter of the load device is in a negative correlation with the load capability of the load device, determining a coordinate position of the load device in the first coordinate system based on a negative value of the first device load parameter of the load device and a value of the second device load parameter of the load device, the load capability being in a negative correlation with a first linear distance of the load device.

6. The method according to claim 3, wherein the enumerating the first group of load devices comprises:
when both a first device load parameter of a load device in the first group of load devices and a second device load parameter of the load device are in a negative correlation with a load capability of the load device, determining a coordinate position of the load device in the first coordinate system based on a value of the first device load parameter and a value of the second device load parameter, the load capability being in a negative correlation with a first linear distance of the load device.

7. The method according to claim 2, wherein the plurality of device load parameters for each load device comprises a first device load parameter, a second device load parameter, and a third device load parameter, and the method further comprises:
enumerating the first group of load devices in a second coordinate system, the second coordinate system comprising a third coordinate axis being associated with first device load parameters of the first group of load devices, a fourth coordinate axis being associated with second device load parameters of the first group of load devices, and a fifth coordinate axis being associated with third device load parameters of the first group of load devices; and
determining a load capability of a load device in the first group of load devices based on a coordinate position of the load device in the second coordinate system, the load capability being related to a second linear distance of the load device, and the second linear distance being a linear distance between the coordinate position of the load device and a coordinate origin of the second coordinate system.

8. The method according to claim 2, wherein the selecting the target first load device comprises:
determining the target first load device to be a load device with a median load capability in the first subset.

9. The method according to claim 2, wherein the plurality of device load parameters for each load device comprises a first device load parameter and a second device load parameter, and the obtaining the respective plurality of device load parameters further comprises:
determining, based on a first weight parameter of a load device in the first group of load devices and a first current device load parameter of the load device, the first device load parameter of the load device, the first current device load parameter of the load device representing a current device load parameter that is in a first dimension and is reported in a latest round by the load device, the first weight parameter representing a ratio of a previous device load parameter that is in the first dimension and is reported by the load device in a historical round to a sum of previous device load parameters that are in the first dimension and are reported by the first group of load devices in the historical round, the historical round representing a round prior to the latest round, and the first device load parameter of the load device being determined according to a sum of the first weight parameter of the load device and the first current device load parameter of the load device; and
determining, based on a second weight parameter of the load device and a second current device load parameter of the load device, the second device load parameter of the load device, the second current device load parameter of the load device representing a device load parameter that is in a second dimension and is reported in the latest round by the load device, the second weight parameter of the load device representing a ratio of a previous device load parameter that is in the second dimension and is reported by the load device in the historical round to a sum of previous device load parameters that are in the second dimension and are reported by the first group of load devices in the historical round, and the second device load parameter of the load device being determined according to a sum of the second weight parameter of the load device and the second current device load parameter of the load device.

10. The method according to claim 1, wherein the selecting the target first load device comprises:
obtaining the respective device load information of the first group of load devices by using a first device allocation process every first duration, the respective device load information of the first group of load devices being reported respectively by the first group of load devices to a first plurality of device allocation processes every second duration by using respective device agent processes on the first group of load devices, the first device allocation process being a predetermined device allocation process in the first plurality of device allocation processes, and the second duration being less than the first duration; and
determining the target first load device from the first subset by using a second device allocation process in response to the first data request.

11. The method according to claim 10, wherein the creating the game on the target first load device comprises:
transmitting a game creation instruction to the target first load device by using the second device allocation process in response to the first data request, the game creation instruction instructing a device agent process of the target first load device to create the game on the target first load device; and
receiving device load information of the target first load device by the second device allocation process, the device load information including one of a creation success instruction or a creation failure instruction.

12. The method according to claim 11, wherein the method further comprises:
obtaining a load consumption parameter that is preset for the game, the load consumption parameter indicating load overheads for creating the game; and
when the game creation instruction has been transmitted to the target first load device by using the second device allocation process and the second device allocation process does not receive the creation success instruction or the creation failure instruction, updating, based on the load consumption parameter and in response to a second data request transmitted by a second access device, device load information of the target first load device, to obtain updated device load information of the first group of load devices.

13. The method according to claim 12, wherein the method further comprises:
when the updated device load information indicates that the target first load device is not able to create another game in response to the second data request,
determining, based on the updated device load information of the first group of load devices, a third group of load devices excluding the first load device, the third group of load devices being a third subset of the first group of load devices,
determining a target second load device from the third subset, and
creating, on the target second load device, a second game corresponding to the second data request.

14. The method according to claim 10, wherein the plurality of device load parameters for each load device comprises a first device load parameter and a second device load parameter, and the method further comprises:
obtaining a total quantity of device allocation processes in the first plurality of device allocation processes;
determining respective first load thresholds and respective second load thresholds of the first group of load devices, a first load threshold and a second load threshold of a load device in the first group of load devices being determined based on a first device load parameter of the load device, a second device load parameter of the load device, and the total quantity of device allocation processes, the first load threshold representing a ratio of the first device load parameter of the load device to the total quantity of device allocation processes, and the second load threshold representing a ratio of the second device load parameter of the load device to the total quantity of device allocation processes; and
determining, in response to the first data request and based on the respective first load thresholds and the respective second load thresholds, the second group of load devices that are allowed to be allocated by the second device allocation process in a current round, a first device load parameter of a load device in the second group of load devices being less than or equal to the first load threshold of the load device, and the second device load parameter of the load device being less than or equal to the second load threshold of the load device.

15. The method according to claim 1, wherein the determining the target load cluster based on network parameters comprises:
sorting the plurality of load clusters based on response speeds and the network parameters between the first access device and the plurality of load clusters, to obtain a target load cluster set;
selecting a load cluster with a highest response speed from the target load cluster set;
determining a cluster load capability of the selected load cluster;
deleting the selected load cluster from the target load cluster set when the cluster load capability does not meet a preset load condition; or
determining the selected load cluster as the target load cluster when the cluster load capability meets the preset load condition.

16. An apparatus for load device determination, comprising processing circuitry configured to:
obtain a first data request that is transmitted by a first access device, the first data request requesting to begin a game in a current application;
determine a target load cluster based on network parameters between the first access device and a plurality of load clusters, the target load cluster being a load cluster in the plurality of load clusters and satisfying a preset network parameter condition, the target load cluster comprising a first group of load devices;
determine a second group of load devices from the first group of load devices based on respective device load information of the first group of load devices,
device load information of a load device in the first group of load devices comprising a plurality of device load parameters in a plurality of dimensions that indicates a load capability for the load device,
the second group of load devices being a first subset of the first group of load devices,
the first group of load devices including the first subset and a second subset, the second subset including load devices of the first group of load devices that are not in the first subset,
for each second load device in the second subset, the first subset including at least a first load device with a first load capability superior to the second load device, and
load capabilities of each pair of first load devices in the first subset being not superior to each other;
select a target first load device from the first subset; and
create the game on the target first load device.

17. The apparatus according to claim 16, wherein the processing circuitry is configured to:
obtain respective plurality of device load parameters for the first group of load devices, a plurality of device load parameters being obtained for each load device in the first group of load devices;
determine respective load capabilities of the first group of load devices, a load capacity being determined for each load device in the first group of load devices; and
determine the first subset based on the respective load capabilities of the first group of load devices.

18. The apparatus according to claim 17, wherein the plurality of device load parameters for each load device comprises a first device load parameter and a second device load parameter, and the processing circuitry is configured to:
enumerate the first group of load devices in a first coordinate system, the first coordinate system comprising a first coordinate axis being associated with first device load parameters of load devices in the first group of load devices, and a second coordinate axis being associated with second device load parameters of the load devices in the first group of load devices; and
determine a load capability of a load device in the first group of load devices based on a coordinate position of the load device in the first coordinate system, the load capability being related to a first linear distance between the coordinate position of the load device and a coordinate origin of the first coordinate system.

19. The apparatus according to claim 18, wherein the processing circuitry is configured to:
determine the target first load device to be a load device with a median load capability in the first subset.

20. A non-transitory computer-readable storage medium storing instructions which when executed by at least one processor cause the at least one processor to perform:
obtaining a first data request that is transmitted by a first access device, the first data request requesting to begin a game in a current application;
determining a target load cluster based on network parameters between the first access device and a plurality of load clusters, the target load cluster being a load cluster in the plurality of load clusters and satisfying a preset network parameter condition, the target load cluster comprising a first group of load devices;
determining a second group of load devices from the first group of load devices based on respective device load information of the first group of load devices,
device load information of a load device in the first group of load devices comprising a plurality of device load parameters in a plurality of dimensions that indicates a load capability for the load device,
the second group of load devices being a first subset of the first group of load devices,
the first group of load devices including the first subset and a second subset, the second subset including load devices of the first group of load devices that are not in the first subset,
for each second load device in the second subset, the first subset including at least a first load device with a first load capability superior to the second load device, and
load capabilities of each pair of first load devices in the first subset being not superior to each other;
selecting a target first load device from the first subset; and
creating the game on the target first load device.
